(19) United States
(12) Patent Application Publication
(10) Pub. No.: US 2009/0294380 A1
(43) Pub. Date: Dec. 3, 2009

(54) Air and Water Treatment Apparatus and Method

(76) Inventor: Adelbert D. Burdge, III, League City, TX (US)

Correspondence Address: BROUSE MCDOWELL LPA, 388 SOUTH MAIN STREET, SUITE 500, AKRON, OH, 44311, US

(21) Appl. No.: 12/473,653

(22) Filed: May 28, 2009

Related U.S. Application Data
(60) Provisional application No. 61/056,676, filed on May 28, 2008.

(51) Int. Cl. C02F 1/00; B01D 46/00

(52) U.S. Cl. 210/749; 210/150; 96/372; 95/273

(57) ABSTRACT

An industrial cleaning system is provided which may comprise a treatment device having at least one inlet and at least one outlet. The treatment device has a gaseous cleansing agent, such as supercharged ozone. It also has a container, wherein the one inlet is operatively connected to the container. The one outlet is operatively connected to the container. The container, the treatment device, the inlet and the outlet are a closed loop system. A contaminated solution is disposed in the container. Power supply is operatively connected to the treatment device. The power supply is adapted to circulate the gaseous cleansing agent through the outlet and into the contaminated solution so as to remove contaminates from the contaminated solution.

This application claims priority to U.S. Ser. No. 61/056,676, titled AIR AND WATER TREATMENT APPARATUS AND METHOD, filed May 28, 2008, which is incorporated herein by reference.

### I. BACKGROUND OF THE INVENTION

A. Field of Invention

This invention pertains to the art of methods and apparatuses for treating air and water so as to remove contaminants.

B. Description of the Related Art

People and business are conscious of environmental issues. Even legislation around environmental issues increased over the years. The industrial cleaning industry maintains a high sensitivity level to these issues. Generally, in the industrial cleaning industry, a water solution is a by-product of the cleaning process. The water would need to be disposed under certain procedures, which comply with today's environmental standards. This disposal is costly and causes inefficiencies in the cleaning processes.

The present invention provides methods and apparatuses for treating air and water so as to remove contaminants.

### II. SUMMARY OF THE INVENTION

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The industrial cleaning system may further comprise a pipe interconnecting the one outlet and the container.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The container may further comprise a top cover, the top cover interconnecting the container and the treatment device.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The contaminated solution may be a water based solution.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The contaminated solution may be an air based solution.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The industrial cleaning system may further comprise a second treatment device having at least one inlet and at least one outlet, the treatment device having a gaseous cleansing agent; a second container, the one inlet being operatively connected to the second container, the one outlet being operatively connected to the second container, the second container, the second treatment device, the inlet and the outlet being a second closed loop system; second power supply operatively connected to the second treatment device, the second power supply adapted to circulate the cleansing agent through the outlet; and, a third power supply interconnecting said container and said second container, wherein said third power supply causes at least a portion of said contaminated solution to be moved into said second container.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The industrial cleaning system may further comprise a second treatment device having at least one inlet and at least one outlet, the treatment device having a gaseous cleansing agent; a second container, the one inlet being operatively connected to the second container, the one outlet being operatively connected to the second container, the second container, the second treatment device, the inlet and the outlet being a second closed loop system; second power supply operatively connected to the second treatment device, the second power supply adapted to circulate the cleansing agent through the outlet; and, a third power supply interconnecting said container and said second container, wherein said third power supply causes at least a portion of said contaminated solution to be moved into said second container. The industrial cleaning system may further comprise a third container having an inlet; and a fourth power supply interconnecting said second container and said third container, wherein said third power supply causes at least a portion of said contaminated solution to be moved into said third container.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. The step of, circulating said gaseous cleansing agent through said closed loop system, wherein a power supply operatively connected to said treatment device causes said gaseous cleansing agent to be circulated through said closed loop system, further comprises the steps of: (a) circulating air from said treatment device through said outlet and into said container; (b) percolating said gaseous cleansing agent through said contaminated solution; (c) drawing vapors from said contaminated solution from said container and through said inlet; (d) repeating steps (a) through (c) until said contaminants from said solution are removed.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. The step of, circulating said gaseous cleansing agent through said closed loop system, wherein a power supply operatively connected to said treatment device causes said gaseous cleansing agent to be circulated through said closed loop system, further comprises the steps of: (a) circulating air from said treatment device through said outlet and into said container; (b) percolating said gaseous cleansing agent through said contaminated solution; (c) drawing vapors from said contaminated solution from said container and through said inlet; (d) repeating steps (a) through (c) until said contaminants from said solution are removed. The step of, circulating air form said treatment device through said outlet and into said container, further comprises the step of: releasing said gaseous cleansing agent beneath a surface level of said contaminated solution.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. A first conduit may interconnect said gaseous cleansing device and said container; and a second conduit may interconnect said container and said inlet.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. A first conduit may interconnect said gaseous cleansing device and said container; and a second conduit may interconnect said container and said inlet. The first conduit may be a pipe.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. A first conduit may interconnect said gaseous cleansing device and said container; and a second conduit may interconnect said container and said inlet. The second conduit may comprise a top cover positioned over the container.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. The method may further comprise the steps of: providing a second treatment device having at least one inlet and at least one outlet, said treatment device having a gaseous cleansing agent; providing a second container, said one inlet being operatively connected to said second container, said one outlet being operatively connected to said second container, said second container, said second treatment device, said inlet and said outlet being a second closed loop system; providing second power supply operatively connected to said second treatment device; providing third power supply interconnecting said container and said second container, wherein said third power supply causes at least a portion of said contaminated solution to be moved into said second container; circulating said gaseous cleansing agent through said second closed loop system; removing contaminates from said contaminated solution in said second container.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. The method may further comprise the steps of: providing a second treatment device having at least one inlet and at least one outlet, said treatment device having a gaseous cleansing agent; providing a second container, said one inlet being operatively connected to said second container, said one outlet being operatively connected to said second container, said second container, said second treatment device, said inlet and said outlet being a second closed loop system; providing second power supply operatively connected to said second treatment device; providing third power supply interconnecting said container and said second container, wherein said third power supply causes at least a portion of said contaminated solution to be moved into said second container; circulating said gaseous cleansing agent through said second closed loop system; removing contaminates from said contaminated solution in said second container. The step of circulating the gaseous cleansing agent through the second closed loop system may further comprise the steps of (a) circulating air from the second treatment device through the outlet and into the second container; (b) percolating the second gaseous cleansing agent through the contaminated solution; (c) drawing vapors from the contaminated solution from the second container and through the inlet; and repeating steps (a) through (c) until the contaminants from the solution in the second container are removed.

According to one embodiment of the invention, a method for removing contaminants from a solution may comprise the steps of providing a treatment device having at least one inlet and at least one outlet, said treatment device having a cleansing agent; providing a container, said one inlet being operatively connected to said container, said one outlet being operatively connected to said container, said container, said treatment device, said inlet and said outlet being a closed loop system; providing a contaminated solution disposed in said container; providing power supply operatively connected to said treatment device; circulating said gaseous cleansing agent through said closed loop system, wherein a power supply operatively connected to said treatment device causes said gaseous cleansing agent to be circulated through said closed loop system; and, removing contaminates from said contaminated solution. The method may further comprise the steps of: providing a second treatment device having at least one inlet and at least one outlet, said treatment device having a gaseous cleansing agent; providing a second container, said one inlet being operatively connected to said second container, said one outlet being operatively connected to said second container, said second container, said second treatment device, said inlet and said outlet being a second closed loop system; providing second power supply operatively connected to said second treatment device; providing third power supply interconnecting said container and said second container, wherein said third power supply causes at least a portion of said contaminated solution to be moved into said second container; circulating said gaseous cleansing agent through said second closed loop system; removing contaminates from said contaminated solution in said second container. The method may further comprise the steps of: providing a third container having an inlet; providing a fourth power supply interconnecting said second container and said third container; and, circulating said decontaminated solution from said second container into said third container, wherein said fourth power supply at least partially causes said decontaminated solution to be circulated from said second container into said third container.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The industrial cleaning system may further comprise a spray bar container; and, a spray bar disposed within said spray bar container, said spray bar having a plurality of openings for passage of said gaseous cleansing agent, wherein said contaminated solution is caused to pass through said spray bar container and into said container.

According to one embodiment of the invention, an industrial cleaning system may comprise a treatment device having at least one inlet and at least one outlet, the treatment device having a gaseous cleansing agent; a container, the one inlet being operatively connected to the container, the one outlet being operatively connected to the container, the container, the treatment device, the inlet and the outlet being a closed loop system; a contaminated solution disposed in the container; power supply operatively connected to the treatment device, the power supply adapted to circulate the gaseous cleansing agent through the outlet and into the contaminated solution so as to remove contaminates from the contaminated solution. The industrial cleaning system may further comprise a spray bar container; a spray bar disposed within said spray bar container, said spray bar having a plurality of openings for passage of said gaseous cleansing agent, wherein said contaminated solution is caused to pass through said spray bar container and into said container; and, a demister box, wherein said demister box causes a vapor gathered above a surface level of said contaminated solution to enter into said treatment device.

One object of the present invention is to provide an apparatus and method for removing contaminants that results in reusable water.

Another object of the present invention is to provide an apparatus and method for removing contaminants that is efficient, simple to use, and cost effective.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 shows a sectional perspective view of an industrial cleaning system according to one embodiment of the invention;

FIG. 2 shows a sectional perspective view of an industrial cleaning system comprising a plurality of cleaning systems according to one embodiment of the invention;

FIG. 3 shows an illustrative schematic view of an industrial cleaning system according to one embodiment of the invention;

FIG. 4 shows a perspective view of a spray bar container comprising a spray bar having three slits located in the two sides and bottom surface of the spray bar container;

FIG. 5 shows a perspective view of a housing for a treatment device according to one embodiment of the invention.

### IV. DETAILED DESCRIPTION OF THE INVENTION

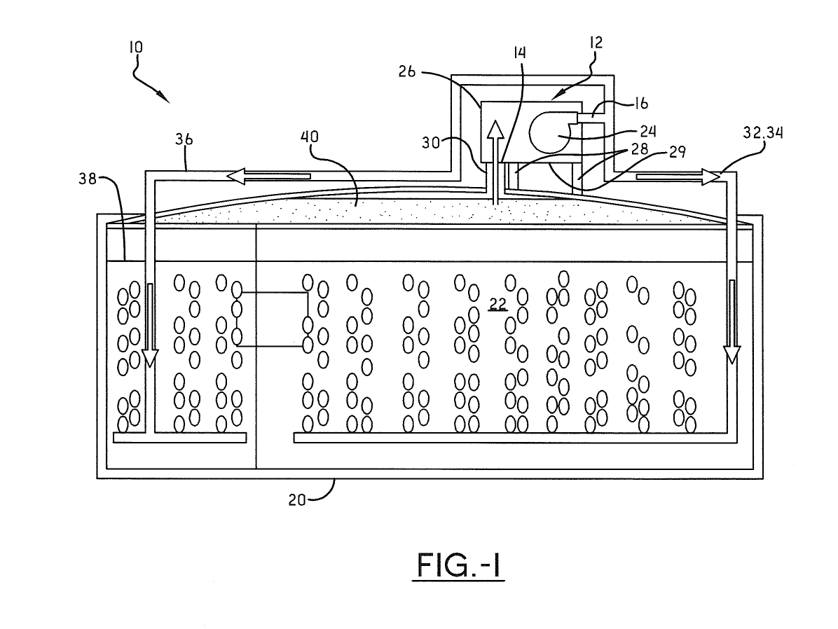

Referring now to the drawings wherein the showings are for purposes of illustrating embodiments of the invention only and not for purposes of limiting the same, FIG. 1 shows an industrial cleaning system 10 according to one embodiment of the invention. The industrial cleaning system 10 may comprise a system for removing contaminates from a contaminated solution 22. In one embodiment, the industrial cleaning system 10 may comprise a treatment device 12, a container 20, and a power supply 24. The treatment device 12 may comprise at least one inlet 14, at least one outlet 16, and a gaseous cleansing agent 18. In one embodiment, the gaseous cleansing agent 18 may comprise supercharged ozone. The inlet 14 and the outlet 16 may be operatively connected to the container 20 such that the container 20, the treatment device 12, the inlet 14 and the outlet 16 comprise a closed loop system. The contaminated solution 22 may be disposed in the container 20. The power supply 24 may be operatively connected to the treatment device 12 and may be adapted to circulate the gaseous cleansing agent 18 through the contaminated solution 22 so as to remove contaminates from the contaminated solution 22.

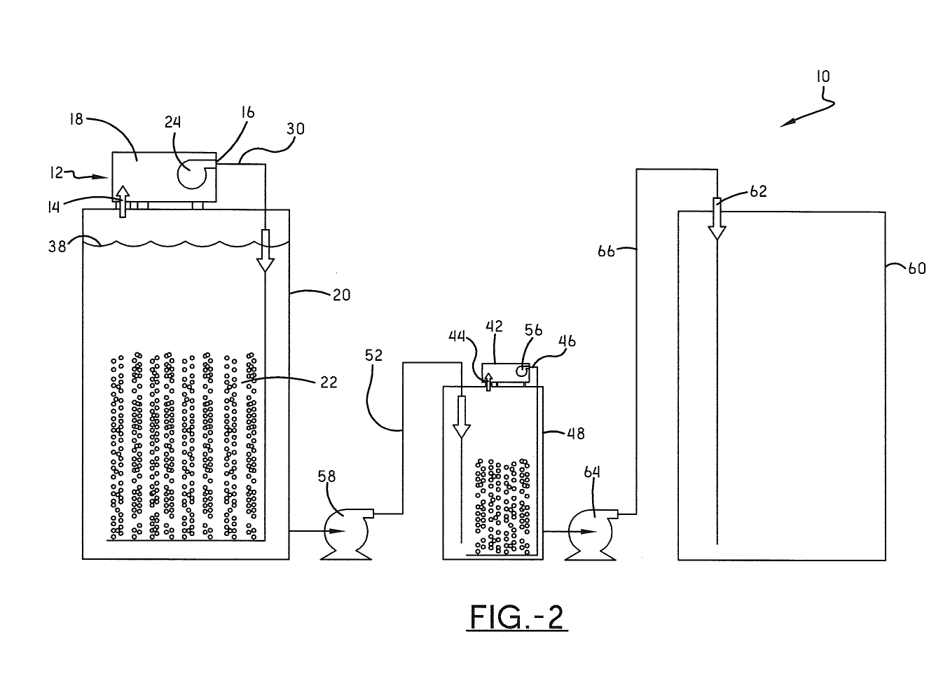

With continuing reference to FIGS. 1 and 2, the treatment device 12 will be described in more detail. The treatment device 12 may comprise a housing 26. The housing 26 may comprise a housing suitable for containing the gaseous cleansing agent 18. In one embodiment, the gaseous cleansing agent 18 may comprise supercharged ozone, which may be O₃, O₄, O₅, O₆ or higher. In one embodiment, the treatment device 12 may comprise a device currently available on the market under the name MICROSWEEP by Clean Air Engineering Inc.

The power supply 24 may be contained within the housing 26 or outside the housing 26. The power supply 24 may be a pump or any other mechanical or electrical mechanical device chosen in accordance with sound engineering judgment to circulate the gaseous cleansing agent 18 throughout the closed loop system. The treatment device 12 may be positioned anywhere in relation to the container 20. In one embodiment, the treatment device 12 may be positioned above, or on top of, the container 20. The housing 26 may further comprise a bottom portion 29 and have legs 28 extending from the bottom portion 29. Vapors may be able to enter the treatment device 12 through a first interconnection member 30. The first interconnection member 30 may provide a flow path for vapors from the container 20 through the inlet 14 and into the treatment device 12. The first interconnection member 30 may take any form chosen in accordance with sound engineering judgment, including, but not limited to, a collar, pipe or tube. Similarly, a second interconnection member 32 may provide a flow path for the gaseous cleansing agent 18 from the outlet 16 to the container 20. The second interconnection member 32 may take any form chosen in accordance with sound engineering judgment, including, but not limited to, a pipe, tube or hose. As shown in FIG. 1, the second interconnection member 32 may branch into separate discharge lines 34, 36. The discharge lines 34, 36 may extend into the bottom of the container 20 below a surface level 38 of the contaminated solution 22.

With reference now to FIG. 1, the container 20 may contain any volume chosen in accordance with sound engineering judgment. The container 20 may further comprise a top cover 40, which contains vapors from the contaminated solution 22. The top cover 40 may take any shape chosen in accordance with sound engineering judgment, including, but not limited to, rectangular or conical. As shown in FIG. 1, the first interconnection member 30 may interconnect the top cover 40 with the treatment device 20.

It is contemplated to be within the scope of the present invention that the contaminated solution 22 may be a water or other liquid-based solution. The contaminated solution 22 may also be a gaseous solution, such as polluted air.

It is also contemplated to be within the scope of the present invention to place a plurality of systems 10 in series in order to decontaminate the solution. With reference to FIG. 2, one example of such a configuration is shown. A first part of the system, which is very similar to that previously described, is shown. A second treatment device 42 may comprise at least one inlet 44 and at least one outlet 46. The second treatment device 42 may comprise a gaseous cleansing agent 47. The gaseous cleansing agent 47 may comprise the same or different cleansing agent as the gaseous cleansing agent 18 utilized in the first treatment device 12. The second treatment device 42 may be disposed on or in proximity to a second container 48. The second container 48, the second treatment device 42, the inlet 50 and the outlet 52 may comprise a second closed loop system. A second contaminated solution 54 may be disposed in the second container 48. The second contaminated solution 54 may come from the first container 20 or from another source (not shown). A second power supply 56 may be operatively connected to the second treatment device 42. The second power supply 56 may be adapted to circulate the cleansing agent 46 through the outlet 52. A third power supply 58 may pump solution from the container 20 and the second container 48 via a third interconnection member 52, such as a pipe, hose, tubing or similar structure.

With reference now to FIG. 2, the system may further comprise a third container 60. The third container 60 may have an inlet 62. A fourth power supply 64 may pump solution from the second container 48 and the third container 60 via a fourth interconnection member 66, such as a pipe, hose, tubing or similar structure. The third container 60 may be another point in the series of the system, or it may be a final container for holding reusable, uncontaminated solution. Further, the second power supply 56, third power supply 58, and fourth power supply 64 may be a pump or any other mechanical or electrical mechanical device chosen in accordance with sound engineering judgment.

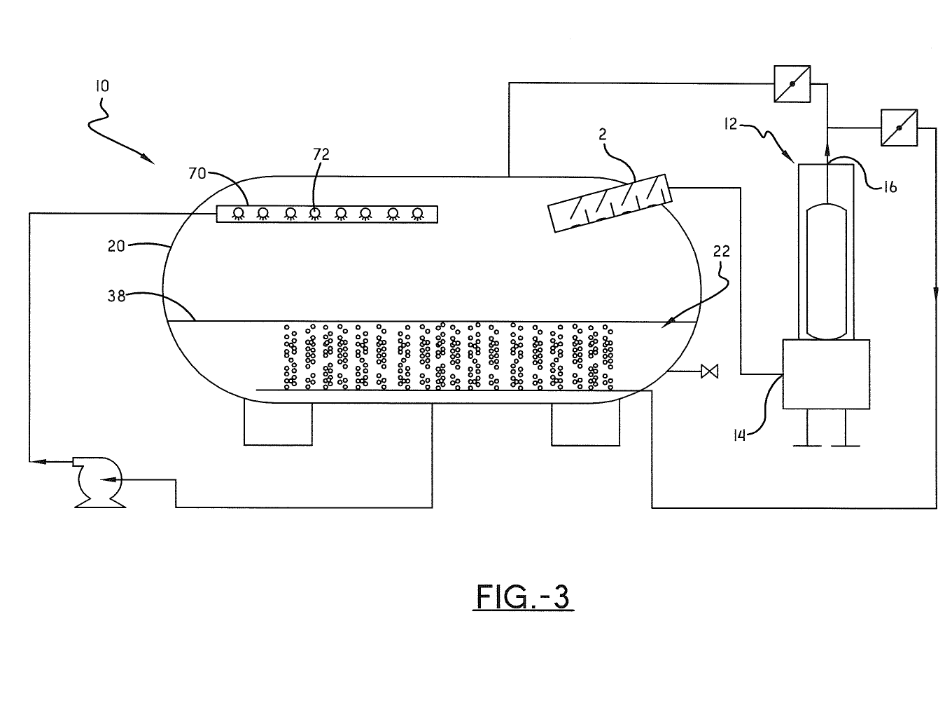

In order to use the present invention, the system previously described is provided. The contaminated solution 22 may be the result of any operation including, industrial cleaning or other industrial process. The contaminated solution 22 may be disposed in the first container 20. The power supply 24 may circulate the gaseous cleansing agent 18 from the treatment device 12, through the outlet 16, and into the container 20. The gaseous cleansing agent 18 may percolate through the contaminated solution 22. The percolating action may comprise a bubble type effect. The bubbles of the gaseous cleansing agent 18 may break down the contaminants in the contaminated solution 22. Vapors may gather above the surface level 38 of the contaminated solution 22. These vapors may enter the treatment device 12 and may also be decontaminated. In one embodiment, shown in FIG. 3, the industrial cleaning system 10 may comprise a demister box 2. The demister box 2 may comprise a device that at least partially causes the vapors gathered above the surface level 38 to be directed into the treatment device 12. The power supply 24 may continuously pump the cleansing agent 18 through the closed loop system until the contaminants have been broken down into a usable substance, such as water. Because the water is decontaminated, it can be reused for future processes, and thus, may significantly decrease costs.

The operation of the invention shown in FIG. 2 may comprise a process that is very similar to that described previously above. After the contaminated solution 22 is circulated through the first closed system, the third power supply 58 may pump or move the contaminated solution 22 into the second container 48 for further processing. Alternatively, the third power supply 58 may pump contaminated solution 22 into the second container 48 from another source, not shown. The process may be repeated whereby the second treatment device 42 may force the gaseous cleansing agent 18 into the contaminated solution 22 to produce a bubble effect. The gaseous cleansing agent 18 may break down the contaminants until the solution is in a reusable or less contaminated state. Finally, the solution in the second container 48 can be pumped into a third container 30 by the fourth power supply 64 for storage until it is ready to be reused.

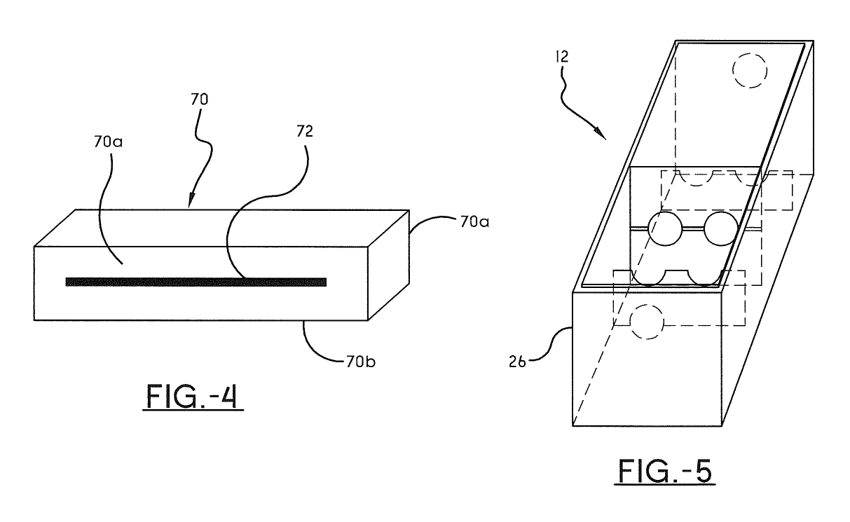

With reference now to FIGS. 3, 4 and 5, in one embodiment, a spray bar container 70 may be incorporated into the process previously described. The spray bar container 70 may comprise a spray bar 72 having a plurality of openings or slits. The spray bar 72 may be positioned substantially within the spray bar container 70. In one embodiment, shown in FIG. 4, the spray bar container 70 may comprise a rectangular spray bar 72 having first and second slits formed in the two side surfaces 70a and a third slit formed in the bottom surface 70b. The spray bar container 70 may be contained within the container 20, within a different vessel of the process system, or other location chosen in accordance with sound engineering judgment. The contaminated solution 22 may trickle down the spray bar 72. The gaseous cleansing agent 18, for example, supercharged ozone, may be sprayed against the trickling contaminated solution via the plurality of openings in the spray bar 72. The gaseous cleansing agent 18 may contact the contaminated solution 22 on all sides, similar to a waterfall action. As the contaminated solution 22 trickles through the spray bar container 70, the contaminated solution 22 may fall through a vapor space in the container 20.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. An industrial cleaning system, comprising:
a treatment device having at least one inlet and at least one outlet, said treatment device having a gaseous cleansing agent;
a container, said one inlet being operatively connected to said container, said one outlet being operatively connected to said container, said container, said treatment device, said inlet and said outlet being a closed loop system;
a contaminated solution disposed in said container; and,
a power supply operatively connected to said treatment device, said power supply adapted to circulate said gaseous cleansing agent through said outlet and into said contaminated solution so as to remove contaminates from said contaminated solution.

2. The industrial cleaning system of claim 1, further comprising a pipe interconnecting said one outlet and said container.

3. The industrial cleaning system of claim 1, wherein said container further comprises a top cover, said top cover interconnecting said container and said treatment device.

4. The industrial cleaning system of claim 1, wherein said contaminated solution is a water-based solution.

5. The industrial cleaning system of claim 1, wherein said contaminated solution is an air-based solution.

6. The industrial cleaning system of claim 1, further comprising:
a second treatment device having at least one inlet and at least one outlet, said treatment device having a gaseous cleansing agent;
a second container, said one inlet being operatively connected to said second container, said one outlet being operatively connected to said second container, said second container, said second treatment device, said inlet and said outlet being a second closed loop system;
a second power supply operatively connected to said second treatment device, said second power supply adapted to circulate said cleansing agent through said outlet; and,
a third power supply interconnecting said container and said second container, wherein said third power supply causes at least a portion of said contaminated solution to be moved into said second container.

7. The industrial cleaning system of claim 6, further comprising:
a third container having an inlet; and,
a fourth power supply interconnecting said second container and said third container, wherein said third power supply causes at least a portion of said contaminated solution to be moved into said third container.

8. A method for removing contaminants from a solution, comprising the steps of:
providing a treatment device having at least one inlet and at least one outlet, said treatment device having a cleansing agent;
providing a container, said one inlet being operatively connected to said container, said one outlet being operatively connected to said container, said container, said treatment device, said inlet and said outlet being a closed loop system;
providing a contaminated solution disposed in said container;
providing power supply operatively connected to said treatment device;
circulating said gaseous cleansing agent through said closed loop system, wherein a power supply operatively connected to said treatment device causes said gaseous cleansing agent to be circulated through said closed loop system; and,
removing contaminates from said contaminated solution.

9. The method of claim 8, wherein said step of, circulating said gaseous cleansing agent through said closed loop system, wherein a power supply operatively connected to said treatment device causes said gaseous cleansing agent to be circulated through said closed loop system, further comprises the steps of:
(a) circulating air from said treatment device through said outlet and into said container;
(b) percolating said gaseous cleansing agent through said contaminated solution;
(c) drawing vapors from said contaminated solution from said container and through said inlet; and,
(d) repeating steps (a) through (c) until said contaminants from said solution are removed.

10. The method of claim 9, wherein said step of, circulating air form said treatment device through said outlet and into said container, further comprises the step of:
releasing said gaseous cleansing agent beneath a surface level of said contaminated solution.

11. The method of claim 8, further comprising:
a first conduit interconnecting said gaseous cleansing device and said container; and
a second conduit interconnecting said container and said inlet.

12. The method of claim 11, wherein said first conduit is a pipe.

13. The method of claim 11, wherein said second conduit comprises a top cover positioned over said container.

14. The method of claim 8, further comprising the steps of:
providing a second treatment device having at least one inlet and at least one outlet, said treatment device having a gaseous cleansing agent;
providing a second container, said one inlet being operatively connected to said second container, said one outlet being operatively connected to said second container, said second container, said second treatment device, said inlet and said outlet being a second closed loop system;
providing second power supply operatively connected to said second treatment device;
providing third power supply interconnecting said container and said second container, wherein said third power supply causes at least a portion of said contaminated solution to be moved into said second container;
circulating said gaseous cleansing agent through said second closed loop system; and,
removing contaminates from said contaminated solution in said second container.

15. The method of claim 14, wherein said step of circulating said gaseous cleansing agent through said second closed loop system further comprises the steps of:
(a) circulating air from said second treatment device through said outlet and into said second container;
(b) percolating said second gaseous cleansing agent through said contaminated solution;
(c) drawing vapors from said contaminated solution from said second container and through said inlet; and,
(d) repeating steps (a) through (c) until said contaminants from said solution in said second container are removed.

16. The method of claim 14, further comprising:
providing a third container having an inlet;
providing a fourth power supply interconnecting said second container and said third container; and,
circulating said decontaminated solution from said second container into said third container, wherein said fourth power supply at least partially causes said decontaminated solution to be circulated from said second container into said third container.

17. The industrial cleaning system of claim 1, further comprising:
a spray bar container;
a spray bar disposed within said spray bar container, said spray bar having a plurality of openings for passage of said gaseous cleansing agent, wherein said contaminated solution is caused to pass through said spray bar container and into said container.

18. The industrial cleaning system of claim 17, further comprising:
a demister box, wherein said demister box causes a vapor gathered above a surface level of said contaminated solution to enter into said treatment device.
